(19) United States
(12) Patent Application Publication
(10) Pub. No.: US 2014/0194019 A1
(43) Pub. Date: Jul. 10, 2014

(54) Silicone Composition, Silicone Adhesive, Coated and Laminated Substrates

(71) Applicant: Dow Corning Corporation, Midland, MI (US)

(72) Inventors: Nathan Greer, Grayling, MI (US); Marilyn Shope, Beaverton, MI (US); Michitaka Suto, Midland, MI (US); Bianxiao Zhong, Midland, MI (US); Bizhong Zhu, Midland, MI (US)

(73) Assignee: Dow Corning Corporation, Midland, MI (US)

(21) Appl. No.: 13/988,118

(22) PCT Filed: Dec. 21, 2011
(86) PCT No.: PCT/US11/66350

§ 371 Date: May 17, 2013

Related U.S. Application Data
(60) Provisional application No. 61/425,914, filed on Dec. 22, 2010.

(51) Int. Cl. C09J 183/06; B32B 17/06

(52) U.S. Cl. CPC C09J 183/06; B32B 17/067
USPC 442/150; 428/354; 428/221; 428/355 R; 528/32; 524/588

(57) ABSTRACT

A silicone composition and more particularly to a silicone composition comprising at least one organosilicon compound having an average of at least two silicon-bonded hydrogen atoms per molecule, at least one silicone resin having the formula (R¹R⁴R⁵SiO_{1/2})_{w}(R¹₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z)=1, and a hydrosilylation catalyst; a silicone adhesive comprising a cured product of the silicone composition, and a coated substrate and a laminated substrate, each comprising the silicone adhesive.

### CROSS-REFERENCE TO RELATED APPLICATIONS

None

### FIELD OF THE INVENTION

The present invention relates to a silicone composition and more particularly to a silicone composition comprising at least one organosilicon compound having an average of at least two silicon-bonded hydrogen atoms per molecule, at least one silicone resin having the formula (R¹R⁴R⁵SiO_{1/2})_{w}(R¹₂SiO_{1/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z≈1, and a hydrosilylation catalyst. The present invention also relates to a silicone adhesive comprising a cured product of the silicone composition. The present invention further relates to a coated substrate and to a laminated substrate, each comprising the silicone adhesive.

### BACKGROUND OF THE INVENTION

Silicone adhesives are useful in a variety of applications by virtue of their unique combination of properties, including high thermal stability, good moisture resistance, excellent flexibility, high ionic purity, low alpha particle emissions, and good adhesion to various substrates. For example, silicone adhesives are widely used in the automotive, electronic, construction, appliance, and aerospace industries.

However, when some conventional silicone adhesives are exposed to high temperatures, for example temperatures encountered by direct contact with an open flame, the adhesives decompose to form a char, typically a nonadherent powder. Other adhesives have high flammability.

In view of the foregoing, there is a need for a silicone composition that cures to form an adhesive having low flammability and high adhesion during and after exposure to temperatures above the decomposition temperature of the adhesive.

### SUMMARY OF THE INVENTION

The present invention is directed to a silicone composition, comprising:

(A) at least one organosilicon compound having an average of at least two silicon-bonded hydrogen atoms per molecule;

(B) at least one silicone resin having the formula (R¹R⁴R⁵SiO_{1/2})_{w}(R¹₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z≈1; and

(C) a hydrosilylation catalyst; wherein the ratio of the number of moles of alkenyl groups in the silicone resin (B) to the number of moles of silicon-bonded hydrogen atoms in the organosilicon compound (A) is from 0.005 to 0.83.

The present invention is also directed to a silicone adhesive comprising a cured product of the silicone composition.

The present invention is further directed to a coated substrate, comprising:

a substrate; and

a silicone adhesive coating on at least a portion of a surface of the substrate, wherein the adhesive coating comprises a cured product of the silicone composition.

The present invention is still further directed to a laminated substrate, comprising:

a first substrate;

at least one additional substrate overlying the first substrate; and

a silicone adhesive coating on at least a portion of at least one surface of each substrate, provided at least a portion of the adhesive coating is between and in direct contact with opposing surfaces of adjacent substrates, wherein the adhesive coating comprises a cured product of the silicone composition.

The silicone composition of the present invention, which comprises a silicone resin having the formula (II), has a prolonged working time compared with a silicone composition containing components (A), (C), and a silicone resin having silicon-bonded alkenyl groups only in the M siloxane units (i.e., R¹R⁴R⁵SiO_{1/2} units).

The silicone adhesive of the present invention has high transparency and excellent adhesion to various substrates. Moreover, the silicone adhesive has high adhesion during and after exposure to temperatures above the decomposition temperature of the adhesive, low flammability, and mechanical toughness, as evidenced by the absence of cracks in the silicone adhesive coating of the laminated substrate of the invention.

The silicone adhesive of the present invention is useful in applications requiring adhesives having high adhesion at elevated temperatures, low flammability, and high transparency. For example, the adhesive is useful for bonding glass panels in the fabrication of fire rated windows and glass firewalls.

These and other features, aspects, and advantages of the present invention will become better understood with reference to the following description, appended claims, and accompanying drawings.

### BRIEF DESCRIPTION OF THE DRAWINGS

FIG. 1 shows a cross-sectional view of one embodiment of a laminated substrate according to the present invention.

FIG. 2 shows a cross-sectional view of the previous embodiment of the laminated substrate, further comprising a second silicone adhesive coating on the second substrate and a third silicone adhesive coating on the second opposing surface of the first substrate.

### DETAILED DESCRIPTION OF THE INVENTION

As used herein, the term “alkenyl group” refers to a monovalent hydrocarbon group containing one aliphatic carbon-carbon double bond.

A silicone composition according to the present invention comprises:

(A) at least one organosilicon compound having an average of at least two silicon-bonded hydrogen atoms per molecule;

(B) at least one silicone resin having the formula (R¹R⁴R⁵SiO_{1/2})_{w}(R¹₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z≈1; and

(C) a hydrosilylation catalyst; wherein the ratio of the number of moles of silicon-bonded alkenyl groups in the silicone resin (B) to the number of moles of silicon-bonded hydrogen atoms in the organosilicon compound (A) is from 0.005 to 0.83.

Component (A) is at least one organosilicon compound having an average of at least two silicon-bonded hydrogen atoms per molecule, alternatively at least three silicon-bonded hydrogen atoms per molecule.

The organosilicon compound can be an organohydrogensilane or an organohydrogensiloxane. The organohydrogensilane can be a monosilane, disilane, trisilane, or polysilane. Similarly, the organohydrogensiloxane can be a disiloxane, trisiloxane, or polysiloxane. The structure of the organosilicon compound can be linear, branched, cyclic, or resinous. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded hydrogen atoms can be located at terminal, pendant, or at both terminal and pendant positions.

Examples of organohydrogensilanes include, but are not limited to, diphenylsilane, 2-chloroethylsilane, bis[(p-dimethylsilyl)phenyl]ether, 1,4-dimethyldisilylethane, 1,3,5-tris(dimethylsilyl)benzene, 1,3,5-trimethyl-1,3,5-trisilane, poly(methylsilylene)phenylene, and poly(methylsilylene)methylene.

The organohydrogensilane can also have the formula HR¹₂S¹—R²—SiR¹₂H, wherein R¹ is C₁ to C₁₀ hydrocarbyl or C₁ to C₁₀ halogen-substituted hydrocarbyl, both free of aliphatic unsaturation, and R² is a hydrocarbylene group free of aliphatic unsaturation having a formula selected from:

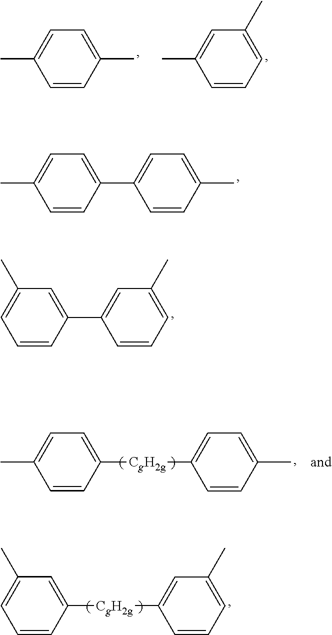

wherein g is from 1 to 6. The hydrocarbyl and halogen-substituted hydrocarbyl groups represented by R¹ are as defined and exemplified above for the silicone resin of component (A).

The hydrocarbyl and halogen-substituted hydrocarbyl groups represented by R¹ are free of aliphatic unsaturation and typically have from 1 to 10 carbon atoms, alternatively from 1 to 6 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl. Examples of halogen-substituted hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

Examples of organohydrogensilanes having the formula HR¹₂S¹—R²—SiR¹₂H, wherein R¹ and R² are as described and exemplified above include, but are not limited to, silanes having the following formulae:

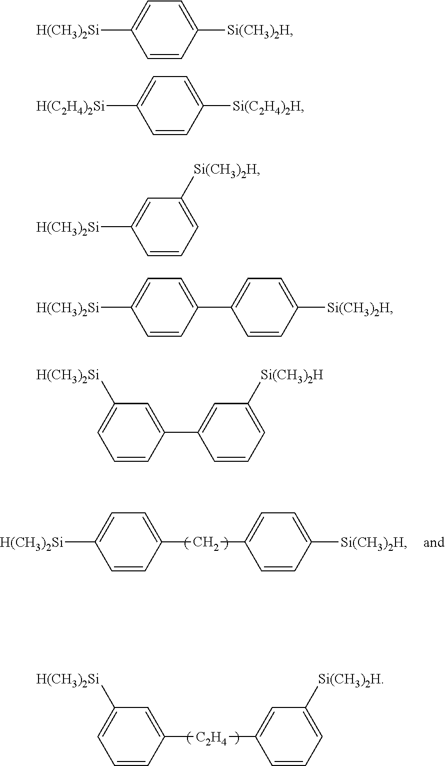

Examples of organohydrogensiloxanes include, but are not limited to, 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), a dimethylhydrogensiloxy-terminated poly(methylhydrogensiloxane), and a resin consisting essentially of HMe₂SiO_{1/2} units, Me₃SiO_{1/2} units, and SiO_{4/2} units, wherein Me is methyl.

According to one embodiment, Component (A) is at least one organohydrogenpolysiloxane having the formula (R¹₂R³SiO_{1/2})ₘ(R¹R³SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R³ is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule. The hydrocarbyl and halogen-substituted hydrocarbyl groups represented by R¹ are as described and exemplified above.

The organohydrogenpolysiloxane having the formula (I) has a linear or branched structure. The organohydrogenpolysiloxane can be a homopolymer containing identical repeat units or a copolymer containing two or more different repeat units. In a copolymer, the units can be in any order. For example, the organohydrogenpolysiloxane can be a random, alternating, or block copolymer.

In the formula (I) of the organohydrogenpolysiloxane, the subscripts m, n, and p are mole fractions. The subscript m typically has a value of from 0.001 to 0.3, alternatively from 0.02 to 0.15, alternatively from 0.02 to 0.05; the subscript n typically has a value of from 0.5 to 0.999, alternatively from 0.6 to 0.9, alternatively from 0.7 to 0.9; and the subscript p typically has a value of from 0 to 0.5, alternatively from 0 to 0.3, alternatively from 0 to 0.15.

Typically at least 50 mol %, alternatively at least 65 mol %, alternatively at least 80 mol % of the groups R³ in the organohydrogenpolysiloxane are hydrogen. The term “mol % of the groups R³ in the organohydrogenpolysiloxane are hydrogen” is defined as the ratio of the number of moles of silicon-bonded hydrogen atoms in the organohydrogenpolysiloxane to the total number of moles of the groups R³ in the organohydrogenpolysiloxane, multiplied by 100.

The organohydrogenpolysiloxane typically has a number-average molecular weight (Mₙ) of from 500 to 50,000, alternatively from 1000 to 20,000, alternatively 2,000 to 10,000, where the molecular weight is determined by gel permeation chromatography employing a refractive index detector and polydimethylsiloxane standards.

The organohydrogenpolysiloxane typically has a viscosity of from 0.01 to 100,000 Pa·s, alternatively from 0.1 to 10,000 Pa·s, alternatively from 0.2 to 20 Pa·s, at 25° C.

Examples of organohydrogenpolysiloxanes having the formula (I) include, but are not limited to, polysiloxanes having the following formulae:

Me₃SiO(MeHSiO_{2/2})_{b}SiMe₃,

Me₃SiO(MeHSiO_{2/2})_{b}(Me₂SiO_{2/2})_{c}SiMe₃,

[Me₃SiO(MeHSiO_{2/2})_{b}]₃(MeSiO_{3/2}),

HMe₂SiO(MeHSiO_{2/2})ₐ(Me₂SiO_{2/2})_{b}SiMe₂H,

HMe₂SiO(MeHSiO_{2/2})ₐ(PhMeSiO_{2/2})_{b}SiMe₂H, and

HMe₂SiO(MeHSiO_{2/2})ₐ(PhMeSiO_{2/2})_{b}(MeSiO_{3/2})_{c}SiMe₂H,

where Me is methyl, and the subscripts b and c, which denote the average numbers of the enclosed units, have values such that the organohydrogenpolysiloxane has a number-average molecular weight of from 500 to 50,000.

Component (A) can be a single organosilicon compound or a mixture comprising two or more different organosilicon compounds, each as described above. For example, component (A) can be a single organohydrogensilane, a mixture of two different organohydrogensilanes, a single organohydrogensiloxane, a mixture of two different organohydrogensiloxanes, or a mixture of an organohydrogensilane and an organohydrogensiloxane.

Methods of preparing organosilicon compounds containing silicon-bonded hydrogen atoms are well known in the art. For example, organohydrogensilanes can be prepared by reaction of Grignard reagents with alkyl or aryl halides. In particular, organohydrogensilanes having the formula HR¹₂S¹—R²—SiR¹₂H can be prepared by treating an aryl dihalide having the formula R²X₂ with magnesium in ether to produce the corresponding Grignard reagent and then treating the Grignard reagent with a chlorosilane having the formula HR¹₂SiCl, where R¹ and R² are as described and exemplified above.

Methods of preparing organohydrogensiloxanes, such as the hydrolysis and condensation of organohalosilanes, are also well known in the art.

Component (B) is at least one silicone resin having the formula (R¹R⁴R⁵SiO_{1/2})_{w}(R¹₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z≈1.

The hydrocarbyl groups represented by R¹ are as described and exemplified above for the organohydrogenpolysiloxane having the formula (I). The alkenyl groups represented by R⁴, which may be the same or different, typically have from 2 to about 4 carbon atoms and are exemplified by, but not limited to, vinyl, allyl, and butenyl.

In the formula (II) of the silicone resin, the subscripts w, x, y, and z are mole fractions. The subscript w typically has a value of from 0.1 to 0.6, alternatively from 0.15 to 0.5, alternatively from 0.2 to 0.4; the subscript x typically has a value of from 0 to 0.5, alternatively from 0 to 0.3, alternatively from 0 to 0.1; the subscript y typically has a value of from 0 to 0.95, alternatively from 0.3 to 0.8, alternatively from 0.4 to 0.7; and the subscript z typically has a value of from 0 to 0.4, alternatively from 0 to 0.2, alternatively from 0 to 0.1.

According to one embodiment of the silicone composition, the silicone resin has the formula (II), wherein R¹, R⁴, and R⁵ are as defined and exemplified above, w is from 0.01 to 0.6, x is 0, y is from 0.1 to 0.95, z is 0, and w+x+y+z≈1.

Furthermore, in the formula (H) of the silicone resin, the sum w+x+y+z≈(is approximately equal to) 1. This means that in addition to units having the average formulas shown in the formula (II) above, the silicone resin may contain residual amounts, e.g., not greater than 5 mol %, of other units such as: (R¹₂SiO_{(2-x′)/2})(OR⁶)_{x′}, (R⁴SiO_{(3-y′)/2})(OR⁶)_{y′}, and (SiO_{(4-z′)/2})(OR⁶)_{z′}, wherein R¹ and R⁴ are as defined and exemplified above, R⁶ is C₁ to C₈ alkyl, x′ is from 0 to 0.05; y′ is from 0 to 0.05; and z′ is from 0 to 0.05.

Typically at least 50 mol %, alternatively at least 65 mol %, alternatively at least 80 mol % of the groups R⁴ in the silicone resin are alkenyl. The term “mol % of the groups R⁴ in the silicone resin are alkenyl” is defined as the ratio of the number of moles of silicon-bonded alkenyl groups in the silicone resin to the total number of moles of the groups R⁴ in the resin, multiplied by 100.

The silicone resin typically has a weight-average molecular weight (M_{w}) of from 500 to 1,000,000, alternatively from 1,000 to 100,000, alternatively from 1,000 to 50,000, alternatively from 1,000 to 20,000, alternatively form 1,000 to 10,000, where the molecular weight is determined by gel permeation chromatography employing a refractive index detector and polystyrene standards.

The silicone resin typically contains less than 10% (w/w), alternatively less than 5% (w/w), alternatively less than 2% (w/w), of silicon-bonded hydroxy groups, as determined by ²⁹Si NMR.

Examples of silicone resins suitable for use as component (B) include, but are not limited to, resins having the following formulae:

(ViMe₂SiO_{1/2})_{0.30}(ViSiO_{3/2})_{0.70}, (ViMe₂SiO_{1/2})_{0.38}(ViSiO_{3/2})_{0.62}, (ViMe₂SiO_{1/2})_{0.29}

(PhMeSiO_{2/2})_{0.17}(ViSiO_{3/2})_{0.54}, and (ViMe₂SiO_{1/2})_{0.27}(Me₂SiO_{2/2})_{0.11}(ViSiO_{3/2})_{0.62},

where Me is methyl, Vi is vinyl, Ph is phenyl, and the numerical subscripts outside the parenthesis denote mole fractions. Also, in the preceding formulae, the sequence of units is unspecified.

Component (B) can be a single silicone resin or a mixture comprising two or more different silicone resins, each as described above. Also, methods of preparing silicone resins containing silicon-bonded alkenyl groups, such as cohydrolysis of the appropriate mixture of chlorosilane precursors, are well known in the art; many of these resins are commercially available.

The concentration of component (B) is sufficient to cure (cross-link) the organosilicon compound of component (A). The exact amount of component (B) depends on the desired extent of cure, which generally increases as the ratio of the number of moles of silicon-bonded alkenyl groups in component (B) to the number of moles of silicon-bonded hydrogen atoms in component (A) increases. The concentration of component (B) is typically sufficient to provide not greater than 0.83 moles of silicon-bonded alkenyl groups, alternatively not greater than 0.5 moles of silicon-bonded alkenyl groups, alternatively not greater than 0.3 moles of silicon-bonded alkenyl groups, per mole of silicon-bonded hydrogen atoms in component (A). For example, the concentration of component (B) is typically sufficient to provide from 0.005 to 0.83 moles of silicon-bonded alkenyl groups, alternatively from 0.1 to 0.7 moles of silicon-bonded alkenyl groups, alternatively from 0.4 to 0.65 moles of silicon-bonded alkenyl groups, per mole of silicon-bonded hydrogen atoms in component (A).

Component (C) of the silicone composition is at least one hydrosilylation catalyst that catalyzes the addition reaction of component (A) with component (B). The hydrosilylation catalyst can be any of the well-known hydrosilylation catalysts comprising a platinum group metal or a compound containing a platinum group metal. Platinum group metals include platinum, rhodium, ruthenium, palladium, osmium and iridium. Typically, the platinum group metal is platinum, based on its high activity in hydrosilylation reactions.

Examples of hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts comprising a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842.

Component (C) can be a single hydrosilylation catalyst or a mixture comprising two or more different catalysts that differ in at least one property, such as structure, form, platinum group metal, complexing ligand, and thermoplastic resin.

The concentration of component (C) is sufficient to catalyze the addition reaction of component (A) with component (B). Typically, the concentration of component (C) is sufficient to provide from 0.1 to 1000 ppm of a platinum group metal, preferably from 0.5 to 500 ppm of a platinum group metal, and more preferably from 1 to 100 ppm of a platinum group metal, based on the combined weight of components (A) and (B). The rate of cure is very slow below 0.1 ppm of platinum group metal. The use of more than 1000 ppm of platinum group metal results in no appreciable increase in cure rate, and is therefore uneconomical.

The silicone composition can comprise additional ingredients, provided the ingredient does not prevent the organohydrogenpolysiloxane from curing to form a silicone adhesive, described below, having high char yield, high adhesion during and after exposure to temperatures above the decomposition temperature of the adhesive, and low flammability. Examples of additional ingredients include, but are not limited to, hydrosilylation catalyst inhibitors, such as 3-methyl-3-penten-1-yne, 3,5-dimethyl-3-hexen-1-yne, 3,5-dimethyl-1-hexyn-3-ol, 1-ethynyl-1-cyclohexanol, 2-phenyl-3-butyn-2-ol, vinylcyclosiloxanes, and triphenylphosphine; adhesion promoters, such as the adhesion promoters taught in U.S. Pat. Nos. 4,087,585 and 5,194,649; dyes; pigments; anti-oxidants; heat stabilizers; UV stabilizers; flame retardants; flow control additives; fillers, such as reinforcing fillers and extending fillers; and diluents, such as organic solvents and reactive diluents.

The silicone composition typically does not contain an organic solvent. However, the composition may further comprise an organic solvent to reduce viscosity of the composition or facilitate application of the composition on a substrate.

In one embodiment, the silicone composition further comprises a reactive diluent. For example, the silicone composition can further comprise a reactive diluent comprising an organosiloxane having an average of at least two silicon-bonded alkenyl groups per molecule and a viscosity of from 0.001 to 2 Pa·s at 25° C., wherein the viscosity of the organosiloxane is not greater than 20% of the viscosity of the organohydrogenpolysiloxane, component (A) above, of the silicone composition and the organosiloxane has the formula (R¹R⁷₂SiO_{1/2}). (R⁷₂SiO_{2/2})_{d}(R¹SiO_{3/2})ₑ(SiO_{4/2})_{f}, wherein R¹ is C₁ to C₁₀ hydrocarbyl or C₁ to C₁₀ halogen-substituted hydrocarbyl, both free of aliphatic unsaturation, R⁷ is R¹ or alkenyl, c is 0 to 0.8, d=0 to 1, e=0 to 0.25, f=0 to 0.2, c+d+e+f=1, and c+d is not equal to 0, provided when e+f=0, d is not equal to 0 and the alkenyl groups are not all terminal. Further, the organosiloxane can have a linear, branched, or cyclic structure.

The viscosity of the organosiloxane at 25° C. is typically from 0.001 to 2 Pa·s, alternatively from 0.001 to 0.1 Pa·s, alternatively from 0.001 to 0.05 Pa·s. Further, the viscosity of the organosiloxane at 25° C. is typically not greater than 20%, alternatively not greater than 10%, alternatively not greater than 1%, of the viscosity of the organohydrogenpolysiloxane in the silicone composition.

Examples of organosiloxanes suitable for use as reactive diluents include, but are not limited to, organosiloxanes having the following formulae: (ViMeSiO)₃, (ViMeSiO)₄, (ViMeSiO)₅, (ViMeSiO)₆, (ViPhSiO)₃, (ViPhSiO)₄, (ViPhMeSi)₂O, (ViMe₂Si)₂O, (ViPhSiO)₅, (ViPhSiO)₆, ViMe₂SiO(ViMeSiO)ₙSiMe₂Vi, Me₃SiO(ViMeSiO)ₙSiMe₃, and (ViMe₂SiO)₄Si, where Me is methyl, Ph is phenyl, Vi is vinyl, and the subscript n has a value such that the organosiloxane has a viscosity of from 0.001 to 2 Pa·s at 25° C.

The reactive diluent can be a single organosiloxane or a mixture comprising two or more different organosiloxanes, each as described above. Methods of making alkenyl-functional organosiloxanes are well known in the art.

The concentration of the reactive diluent in the silicone composition is typically from 1 to 20% (w/w), alternatively from 1 to 10% (w/w), alternatively from 1 to 5% (w/w), based on the combined weight of the organosilicon compound, component (A), and the silicone resin, component (B).

Also, the concentration of the reactive diluent in the silicone composition is such that the ratio of the sum of the number of moles of alkenyl groups in the silicone resin, component (B), and the reactive diluent to the number of moles of silicon-bonded hydrogen atoms in the organosilicon compound, component (A), is typically from 0.005 to 0.83, alternatively from 0.1 to 0.7, alternatively from 0.4 to 0.65.

In one embodiment, the silicone composition further comprises at least one ceramic filler. Examples of ceramic fillers include, but are not limited to, nitrides such as silicon nitride, boron nitride, aluminum nitride, titanium nitride, and zirconium nitride; carbides such as silicon carbide, boron carbide, tungsten carbide, titanium carbide, zirconium carbide, and molybdenum carbide; metal oxides, such as the oxides of aluminum, magnesium, zinc, beryllium, zirconium, titanium and thorium; silicates, such as the silicates of aluminum, magnesium, zirconium, and titanium; and complex silicates, such as magnesium aluminum silicate.

The silicone composition is typically prepared by combining the principal components and any optional ingredients in the stated proportions at ambient temperature, with or without the aid of an organic solvent. Although the order of addition of the various components is not critical if the silicone composition is to be used immediately, the hydrosilylation catalyst is preferably added last at a temperature below about 30° C. to prevent premature curing of the composition.

Mixing can be accomplished by any of the techniques known in the art such as milling, blending, and stirring, either in a batch or continuous process. The particular device is determined by the viscosity of the components and the viscosity of the final silicone composition.

A silicone adhesive according to the present invention comprises a cured product of the silicone composition described above. As used herein, the term “cured product of the silicone composition” refers to a cross-linked polysiloxane having a three-dimensional network structure.

The silicone adhesive typically has high transparency. The transparency of the adhesive depends on a number of factors, such as the composition and thickness of the adhesive. For example, a silicone adhesive film having a thickness of 50 μm typically has a % transmittance of at least 80%, alternatively at least 90%, for light in the visible region (˜400 to ˜700 nm) of the electromagnetic spectrum.

The silicone adhesive can be prepared by curing the silicone composition described above. The silicone composition can be cured by exposing the composition to a temperature of from room temperature (˜23±2° C.) to 250° C., alternatively from room temperature to 200° C., alternatively from room temperature to 150° C., at atmospheric pressure. The silicone composition is generally heated for a length of time sufficient to cross-link the organosilicon compound. For example, the composition is typically heated at a temperature of from 150 to 200° C. for a time of from 0.1 to 3 h. Alternatively, when the hydrosilylation catalyst is a photoactivated hydrosilylation catalyst, the silicone composition can be cured by exposing the composition to radiation having a wavelength of from 150 to 800 nm.

According to the present invention, a coated substrate comprises:

a substrate; and

a silicone adhesive coating on at least a portion of a surface of the substrate, wherein the adhesive coating comprises a cured product of the silicone composition described above.

The substrate can be any rigid or flexible material having a planar, complex, or irregular contour. The substrate can be transparent or nontransparent to light in the visible region (˜400 to ˜700 nm) of the electromagnetic spectrum. Also, the substrate can be an electrical conductor, semiconductor, or nonconductor. Examples of substrates include, but are not limited to, semiconductors such as silicon, silicon having a surface layer of silicon dioxide, silicon carbide, indium phosphide, and gallium arsenide; quartz; fused quartz; aluminum oxide; ceramics; glass such as soda-lime glass, borosilicate glass, lead-alkali glass, borate glass, silica glass, alumino-silicate glass, lead-borate glass, sodium borosilicate glass, lithium aluminosilicate glass, Chalcogenide glass, phosphate glass, and alkali-barium silicate glass; metal foils; polyolefins such as polyethylene, polypropylene, polystyrene, polyethylene terephthalate (PET), and polyethylene naphthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones.

In addition, the substrate can be a reinforced silicone resin film prepared by impregnating a fiber reinforcement (e.g., woven or nonwoven glass fabric, or loose glass fibers) in a curable silicone composition comprising a silicone resin, and heating the impregnated fiber reinforcement to cure the silicone resin. Reinforced silicone resin films prepared from various types of curable silicone compositions are known in the art, as exemplified in the following International Patent Application Publications: WO2006/088645, WO2006088646, WO2007/092032, and WO2007/018756.

The coated substrate comprises a silicone adhesive coating on at least a portion of a surface of the substrate. The silicone adhesive coating may be on a portion of one or more surfaces of the substrate or on all of one or more surfaces. For example, when the substrate is a flat panel, the silicone adhesive coating may be on one side, on both sides, or on both sides and the edges, of the substrate.

The silicone adhesive coating comprises a cured product of the silicone composition described above. The silicone adhesive coating can be a single layer coating comprising one layer of a silicone adhesive, or a multiple layer coating comprising two or more layers of at least two different silicone adhesives, where directly adjacent layers comprise different silicone adhesives (i.e., cured products have a different composition and/or property). The multiple layer coating typically comprises from 2 to 7 layers, alternatively from 2 to 5 layers, alternatively from 2 to 3 layers.

The single layer silicone adhesive coating typically has a thickness of from 0.03 to 300 μm, alternatively from 0.1 to 100 μm, alternatively from 0.1 to 50 μm. The multiple layer coating typically has a thickness of from 0.06 to 300 μm, alternatively from 0.2 to 100 μm, alternatively 0.2 to 50 μm. When the thickness of the silicone adhesive coating is less than 0.03 μm, the coating may become discontinuous. When the thickness of the silicone adhesive coating is greater than 300 μm, the coating may exhibit reduced adhesion and/or cracking.

The coated substrate can be prepared by forming a silicone adhesive coating on a substrate, where the adhesive coating and the substrate are as defined and exemplified above. For example, a coated substrate comprising a single-layer silicone adhesive coating can be prepared by (i) applying a silicone composition, described above, on a substrate to form a film, and (ii) curing the silicone composition of the film. The silicone composition can be applied on the substrate using conventional methods such as spin coating, dip coating, spray coating, flow coating, screen printing, and roll coating. When present, the solvent is typically allowed to evaporate from the coated substrate before the film is heated. Any suitable means for evaporation may be used such as simple air drying, applying a vacuum, or heating (up to 50° C.).

The silicone composition of the film can be cured under the conditions described above in the method of preparing the silicone adhesive of the present invention.

The method of preparing the coated substrate, wherein the coating comprises a single layer adhesive coating can further comprise repeating the steps (i) and (ii) to increase the thickness of the coating, except the silicone composition is applied on the cured adhesive film rather than the substrate, and the same silicone composition is used for each application.

A coated substrate comprising a multiple layer silicone adhesive coating can be prepared in a manner similar to the method used to prepare a single layer coating, only adjacent layers of the coating are prepared using a silicone composition having a different composition and typically each film is at least partially cured before applying the silicone composition of the next layer. For example, a coated substrate comprising a silicone adhesive coating having two layers can be prepared by (i) applying a silicone composition, described above, on a substrate to form a first film, (ii) at least partially curing the silicone composition of the first film, (iii) applying a silicone composition different from the composition in (i), on the at least partially cured first film to form a second film, and (iv) curing the silicone composition of the second film.

A laminated substrate according to the present invention comprises:

a first substrate;

at least one additional substrate overlying the first substrate; and

a silicone adhesive coating on at least a portion of at least one surface of each substrate, provided at least a portion of the adhesive coating is between and in direct contact with opposing surfaces of adjacent substrates, wherein the adhesive coating comprises a cured product of the silicone composition described above.

As used herein, the term “overlying” used in reference to the additional substrates means each additional substrate occupies a position over, but not in direct contact with, the first substrate and any intervening substrate(s).

The substrates and the silicone adhesive coating of the laminated substrate are as described and exemplified above for the coated substrate of the present invention. The laminated substrate comprises a first substrate and at least one additional substrate. The laminated substrate typically contains from 1 to 20 additional substrates, alternatively from 1 to 10 additional substrates, alternatively from 1 to 4 additional substrates. When the laminated substrate is a laminated glass substrate, at least one of the substrates is glass and, optionally, at least one of the substrates is a reinforced silicone resin film, described above.

The laminated substrate comprises a silicone adhesive coating on at least a portion of at least one surface of each substrate. The adhesive coating may be on a portion of one or more surfaces of each substrate or on all of one or more surfaces of each substrate. For example, when the laminated substrate is a laminated glass comprising glass panes, the silicone adhesive coating may be on one side, on both sides, or on both sides and the edges, of each pane.

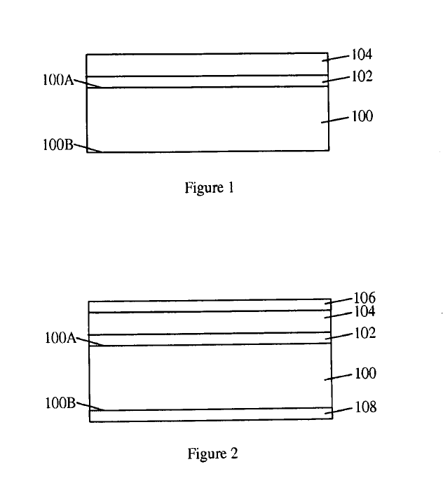

As shown in FIG. 1, one embodiment of a laminated substrate according to the present invention comprises a first substrate 100 having a first opposing surface 100A and a second opposing surface 100B; a first silicone adhesive coating 102 on the first opposing surface 100A of the first substrate 100, wherein the first silicone adhesive coating 102 comprises a cured product of the silicone composition described above; and a second substrate 104 on the first silicone adhesive coating 102.

As shown in FIG. 2, the preceding embodiment of the laminated substrate can further comprise a second silicone adhesive coating 106 on the second substrate 104 and a third silicone adhesive coating 108 on the second opposing surface 100B of the first substrate 100, wherein the second and third adhesive coatings each comprise a cured product of the silicone composition described above.

A suitable method of preparing the laminated substrate is illustrated here for the laminated substrate depicted in FIG. 1. The laminated substrate can be prepared by (i) applying a silicone composition, described above, on a first surface of a substrate to form a first adhesive film; (ii) applying a second substrate on the first adhesive film; and (iii) curing the silicone composition of the first adhesive film. Laminated substrates comprising additional silicone adhesive coatings and substrates can be prepared in a similar manner. When the laminated substrate comprises at least one multiple layer silicone adhesive coating, typically each layer of the coating is at least partially cured before the next layer is formed.

The silicone composition of the present invention, which comprises a silicone resin having the formula (II), has a prolonged working time compared with a silicone composition containing components (A), (C), and a silicone resin having silicon-bonded alkenyl groups only in the M siloxane units (i.e., R¹R⁴R⁵SiO_{1/2} units).

The silicone adhesive of the present invention has high transparency and excellent adhesion to various substrates. Moreover, the silicone adhesive has high adhesion during and after exposure to temperatures above the decomposition temperature of the adhesive, low flammability, and mechanical toughness, as evidenced by the absence of cracks in the silicone adhesive coating of the laminated substrate of the invention.

The silicone adhesive of the present invention is useful in applications requiring adhesives having high adhesion at elevated temperatures, low flammability, and high transparency. For example, the adhesive is useful for bonding glass panels in the fabrication of fire rated windows and glass firewalls.

### EXAMPLES

The following examples are presented to better illustrate the silicone composition and laminated substrate of the present invention, but are not to be considered as limiting the invention, which is delineated in the appended claims. Unless otherwise noted, all parts and percentages reported in the examples are by weight. The following methods and materials were employed in the Examples:

### Measurement of Work Time

The Work Time of silicone compositions was determined according to the following method: The Organosilicon Compound, Silicone Resin, and Catalyst were combined in a HDPE mixing cup. The flowability of the mixture at room temperature (˜23° C.) was checked visually every 5 min. for the first 2 h and every hour thereafter, by tilting the cup. The time required for the mixture to become nonflowable was taken as the Work Time.

### Flame Test Method

Flame testing of laminated glass composites was carried out according to the following procedure: One glass surface of the composite, arbitrarily designated the front side, was contacted with a torch supplied with propylene at a pressure of 10 psi (6.9×10⁴ Pa) for 10 min. The orifice of the torch had a diameter of 2.5 in. and was positioned 11 in. from the surface. During the exposure period, an ignition source (continuous spark generator) was placed approximately 1 cm from the unexposed side (backside) of the composite. The presence and absence of backside ignition (flaming) were recorded as Yes and No, respectively. The composite was then allowed to cool to room temperature. Each composite was visually inspected and assigned an adhesion level from 0 to 10 based on the criteria in Table 3.

### Fire Test Method

Fire testing of laminated glass composites was conducted in accordance with ASTM Standard E2010-01, Standard Test Method for Positive Pressure Fire Tests of Window Assemblies, except the application of a hose stream was omitted. Structural failure time is the time required to create a through-opening (see section 12.1.1.4, ASTM E2010-01). Exterior flame on glass is the time period during which a flame was observed on the unexposed face of the test assembly (see section 12.1.2.1, ASTM E2010-01). Exterior flame intensity refers to the percentage of cracks on the unexposed surface from which a flame emerged.

M^{Vi}_{0.35}T^{Vi}_{0.65} is a silicone resin having the formula (ViMe₂SiO_{1/2})_{0.33}(ViSiO_{3/2})_{0.65}, where Me is methyl, Vi is vinyl, and the subscripts outside the parenthesis denote mole fractions.

M^{Vi}_{0.33}T^{Vi}_{0.67} is a silicone resin having the formula (ViMe₂SiO_{1/2})_{0.33}(ViSiO_{3/2})_{0.67}, where Me is methyl, Vi is vinyl, and the subscripts outside the parenthesis denote mole fractions.

M^{Vi}_{0.33}D_{0.10}T^{Vi}_{0.57} is a silicone resin having the formula (ViMe₂SiO_{1/2})_{0.33}(Me₂SiO_{2/2})_{0.10}(ViSiO_{3/2})_{0.5}7, where Me is methyl, Vi is vinyl, and the subscripts outside the parenthesis denote mole fractions.

M^{Vi}_{0.20}D_{0.43}T^{Me}_{0.20}T^{Ph}_{0.17} is a silicone resin having the formula (ViMe₂SiO_{1/2})_{0.20} (Me₂SiO_{2/2})_{0.43}(MeSiO_{3/2})_{0.20}(PhSiO_{3/2})_{0.17}, where Me is methyl, Ph is phenyl, Vi is vinyl, and the subscripts outside the parenthesis denote mole fractions.

T^{Ph}_{0.20}T^{Me}_{0.20}D_{0.40}M^{Vi}_{0.20} is a silicone resin having the formula (PhSiO_{3/2})_{0.20} (MeSiO_{3/2})_{0.20}(Me₂SiO_{2/2})_{0.40}(ViMe₂SiO_{1/2})_{0.20}, where Me is methyl, Ph is phenyl, Vi is vinyl, and the subscripts outside the parenthesis denote mole fractions.

T^{Ph}_{0.20}D_{0.60}M^{Vi}_{0.20} is a silicone resin having the formula (PhSiO_{3/2})_{0.20}(Me₂SiO_{2/2})_{0.60}(ViMe₂SiO_{1/2})_{0.20}, where Me is methyl, Ph is phenyl, Vi is vinyl, and the subscripts outside the parenthesis denote mole fractions.

M^{Vi}_{0.29}D_{0.17}T^{Vi}_{0.63} is a silicone resin having the formula (ViMe₂SiO_{1/2})_{0.29} (Me₂SiO_{2/2})_{0.17}(ViSiO_{3/2})_{0.63}, where Me is methyl, Vi is vinyl, and the subscripts outside the parenthesis denote mole fractions.

Organosilicon Compound A is a poly(hydrogenmethyl)siloxane having the formula Me₃SiO(HMeSiO)₆₅SiMe₃, where Me is methyl and the subscript outside the parenthesis denotes the average number of the enclosed unit.

Organosilicon Compound B is an organohydrogenpolysiloxane resin having the formula (HMe₂SiO_{1/2})_{0.03}(PhMeSiO_{2/2})_{0.32}(HMeSiO_{2/2})_{0.65}, where Mc is methyl, Ph is phenyl, and the subscripts outside the parenthesis denote mole fractions.

Catalyst A is a mixture prepared by treating a platinum(0) complex of 1,1,3,3-tetramethyldisiloxane in the presence of a large molar excess of 1,1,3,3-tetramethyldisiloxane, with triphenylphosphine to achieve a mole ratio of triphenylphosphine to platinum of about 4:1 and a platinum concentration of 1000 ppm.

Catalyst B is a mixture containing a platinum(0) complex of 1,3-divinyl-1,1,3,3,-tetramethyldisiloxane in toluene, and having a platinum concentration of 1000 ppm.

Silicone Base is a mixture containing 82% of a silicone resin having the formula (PhSiO_{3/2})_{0.75}(ViMe₂SiO_{1/2})_{0.25}, where the resin has a weight-average molecular weight of about 1700, a number-average molecular weight of about 1440, and contains about 1 mol % of silicon-bonded hydroxy groups; and 18% of 1,4-bis(dimethylsilyl)benzene. The mole ratio of silicon-bonded hydrogen atoms in the 1,4-bis(dimethylsilyl)benzene to silicon-bonded vinyl groups in the silicone resin is 1.1:1, as determined by ²⁹SiNMR and ¹³CNMR.

Melinex® 516, sold by Dupont Teijin Films (Hopewell, Va.), is a polyethylene-terephthalate (PET) film pretreated on one side with a release agent for slip and having a thickness of 125 μm.

Glass Fabric is a heat-treated glass fabric prepared by heating style 106 electrical glass fabric having a plain weave and a thickness of 37.5 μm at 575° C. for 6 h. The untreated glass fabric was obtained from JPS Glass (Slater, S.C.).

### Example 1

Silicone Base was mixed with 0.5% (w/w), based on the weight of the Base, of Catalyst B. The resulting composition was applied on the release agent-treated surface of a Melinex® 516 PET film (8 in.×11 in.) to form a silicone film. Glass Fabric having the same dimensions as the PET film was carefully laid down on the silicone film, allowing sufficient time for the composition to thoroughly wet the fabric. The aforementioned silicone composition was then uniformly applied to the embedded fabric. An identical PET film was placed on top of the coating with the release agent-treated side in contact with the silicone composition. The stack was then passed between two stainless steel bars separated by a distance of 300 μm. The laminate was heated in an oven according at 150° C. for 10 min. The oven was turned off and the laminate was allowed to cool to room temperature inside the oven. The upper PET film was separated (peeled away) from the reinforced silicone resin film, and the silicone resin film was then separated from the lower PET film. The transparent reinforced silicone resin film had a thickness of about 125 μm.

### Examples 2-5

In each of Examples 2-5 a silicone composition was prepared by combining the appropriate Organosilicon Compound, Silicone Resin, and Catalyst in the amounts specified in Table 1. The work time of each composition is reported in Table 2.

Laminated glass composites were prepared using each of the silicone compositions according to the following procedure: Two flat float glass plates (6 in.×6 in.×⅛ in.) were washed with a warm solution of detergent in water, thoroughly rinsed with deionized water, and dried in air. Approximately 2 g of the silicone composition was applied on one side of each glass plate. The reinforced silicone resin film of Example 1 having the same dimensions as the glass plates was placed on the coated surface of one of the glass plates, and the coated surface of the other glass plate was then placed on the exposed surface of the reinforced silicone resin film. The laminate was held under vacuum (2500 Pa) at room temperature for 2 h. The composite was heated in an oven at a rate of 3° C./min. to 150° C., at which temperature the laminate was maintained for 2 h. The oven was turned off and the laminated glass was allowed to cool to room temperature inside the oven. The composite was subjected to flame testing as described in the Introduction to the Examples section. The adhesion level of each composite is reported in Table 4.

### Comparative Examples 1 and 2

In each of Comparative Examples 1 and 2 a silicone composition was prepared using the components and amounts specified in Table 1. The work time of each composition is reported in Table 2. Laminated glass composites were prepared and tested using the methods of Examples 2-5. The adhesion level of each composite is reported in Table 4.

### Examples 6-8

In each of Examples 6-8 a silicone composition was prepared by combining the appropriate Organosilicon Compound, Silicone Resin, and Catalyst in the amounts specified in Table 1. The work time of each composition is reported in Table 2. Laminated glass composites were prepared using the method described above in Examples 2-5, except the glass plates were replaced with glass panels measuring 1 meter×1 meter×6.2 mm. The composites were subjected to fire testing as described in the Introduction to the Examples section. The fire test results for each composite are reported in Table 5.

### Comparative Examples 3 and 4

In each of Comparative Examples 3 and 4 a silicone composition was prepared using the components and amounts specified in Table 1. The work time for each composition is reported in Table 2. Laminated glass composites were prepared and tested using the methods of Examples 6-8. The fire results for each composite are reported in Table 5.

TABLE 1
Silicone Compositions

| | Parts by Weight | | | | | | | | | | |
|---|---|---|---|---|---|---|---|---|---|---|---|
| | Example | | | | | | | | | | |
| Component | 2 | 3 | 4 | 5 | 6 | 7 | 8 | C-1 | C-2 | C-3 | C-4 |
| Organosilicon Compound | | | | | | | | | | | |
| A | 53.80 | 59.52 | 64.69 | 52.56 | 54.32 | — | 50.60 | 29.78 | 30.13 | 29.97 | 45.76 |
| B | — | — | — | — | — | 71.54 | — | — | — | — | — |
| Silicone Resin | | | | | | | | | | | |
| M^{vi}_{0.35}T^{vi}_{0.65} | 45.21 | — | — | — | 44.68 | — | — | — | — | — | — |
| M^{vi}_{0.33}T^{vi}_{0.67} | — | 39.49 | 34.31 | — | — | 26.02 | — | — | — | — | — |
| M^{vi}_{0.33}D_{0.10}T^{vi}_{0.57} | — | — | — | 46.45 | — | — | — | — | — | — | — |
| M^{vi}_{0.20}D_{0.43}T^{Me}_{0.20}T^{Ph}_{0.17} | — | — | — | — | — | — | — | 69.23 | 69.78 | — | — |
| M^{vi}_{0.29}D_{0.17}T^{vi}_{0.63} | — | — | — | — | — | — | 48.90 | — | — | — | — |
| T^{Ph}_{0.20}T^{Me}_{0.20}D_{0.40}M^{vi}_{0.20} | — | — | — | — | — | — | — | — | — | 69.93 | — |
| T^{Ph}_{0.20}D_{0.60}M^{vi}_{0.20} | — | — | — | — | — | — | — | — | — | — | 54.14 |
| Catalyst | | | | | | | | | | | |
| A | 0.10 | 0.10 | 0.10 | 0.10 | — | — | — | 0.10 | 0.01 | — | — |
| B | — | — | — | — | 0.10 | 0.25 | 0.005 | — | — | 0.01 | 0.01 |
| *Si—H/Si—Vi | 1.60 | 2.02 | 2.53 | 1.67 | 1.63 | 1.85 | 1.61 | 3.01 | 3.01 | 3.00 | 6.00 |

C-1, C-2, C-3, and C-4 denote Comparative Examples 1, 2, 3, and 4, respectively
*Si—H/Si—Vi denotes the mole ratio silicon-bonded hydrogen atoms in the Organosilicon Compound to silicon-bonded vinyl groups in the Silicone Resin

TABLE 2

| | Work Time |
|---|---|
| Example | Hour(s) |
| 2 | >12 |
| 3 | >12 |
| 4 | >12 |
| 5 | >12 |
| 6 | 45 |
| 7 | 118 |
| 8 | 73 |
| C-1 | <0.1 |
| C-2 | 2 |
| C-3 | 2 |
| C-4 | 2 |

TABLE 3
Criteria for Assigning Adhesion Level

| Adhesion | | |
|---|---|---|
| Level | Description | Corresponding Observation When Examined After Flame Test |
| 0 | None | No adhesion at all, burned glass pieces has no film on and come |
| | | apart instantly |
| 1 | Very weak | |
| 2 | Weak | Few pieces of glass shards attached to at least one side of the |
| | | browned area of film, but easily come off |
| 3 | Weak-fair | More pieces of glass shards attached to at least one side of the |
| | | browned and/or blackened area of the film, but easily come off |
| 4 | fair | Many pieces of glass shards attached to at least one side of the |
| | | browned and/or blackened area of the film, but fairly easily |
| | | come off |
| 5 | fair-good | Similar to 4, but glass shards come off less easily |
| 6 | fair-good+ | similar to 5, but glass shards come off only after peeling by |
| | | hand |
| 7 | good | At least there is one area where both sides of the glass attached |
| | | to the blackened area of the film after breaking the glass, and on |
| | | at least one side of the film glass shard show very good |
| | | adhesion |
| 8 | good-very | More pieces of glass shards attached to both sides of the |
| | good | blackened area of the film, and on at least one side of the film |
| | | glass shard show very good adhesion |
| 9 | very good | Similar to 8, but double side glued glass shard needs hand |
| | | peeling to come off |
| 9.5 | very good+ | Similar to 9, but both sides of the blackened area extensively |
| | | glued together and cannot be peeled off easily |
| 10 | Excellent | Similar to 9.5, but both sides of the blackened area very |
| | | extensively glued together and needs significant peeling force |
| | | to separate |

TABLE 4
Flame Test Results

| | Back | |
|---|---|---|
| | Side | Adhesion |
| Example | Flame | Level |
| 2 | No | 6.5 |
| 3 | No | 7 |
| 4 | No | 9 |
| 5 | No | 6.5 |
| C-1 | † | † |
| C-2 | No | 6.5 |

† Unable to prepare composite due to insufficient work time of composition

TABLE 5
Fire Test Results

| | | Structural | | |
|---|---|---|---|---|
| | Laminate | failure | Exterior | Exterior |
| | Before Fire | time, | flame | flame |
| Example | Test | min. | on glass | intensity |
| 6 | Few hairline | 32 | No | No |
| | cracks in | | flame | flame |
| | interlayer | | | |
| 7 | No crack, no | 49 | No | No |
| | delamination | | flame | flame |
| 8 | Few hairline | 22 | No | No |
| | cracks in | | flame | flame |
| | interlayer | | | |
| C-3 | Severe | 32 | From | ~65% |
| | cracks in | | 7.5 to | cracks |
| | interlayer | | 23.3 min. | |
| C-4 | Severe | 47 | From | ~65% |
| | cracks in | | 5.5 to | cracks |
| | interlayer | | 16.8 min. | |

1. A silicone composition, comprising:
(A) at least one organosilicon compound having an average of at least two silicon-bonded hydrogen atoms per molecule;
(B) at least one silicone resin having the formula (R¹R⁴R⁵SiO_{1/2})_{w}(R¹₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is C₂ to C₄ alkenyl, R⁵ is R¹ or R⁴, w is from 0.01 to 0.6, x is from 0 to 0.5, y is from 0.1 to 0.95, z is from 0 to 0.4, and w+x+y+z≈0.1; and
(C) a hydrosilylation catalyst; wherein the ratio of the number of moles of alkenyl groups in the silicone resin (B) to the number of moles of silicon-bonded hydrogen atoms in the organosilicon compound (A) is from 0.005 to 0.83.

2. The silicone composition according to claim 1, wherein the organosilicon compound is at least one organohydrogenpolysiloxane having the formula (R¹₂R³SiO_{1/2})ₘ(R¹R³SiO_{2/2})ₙ(R¹SiO_{3/2})ₚ (I), wherein each R¹ is independently C₁ to C₁₀ hydrocarbyl or C₁ to C₁₀ halogen-substituted hydrocarbyl, both free of aliphatic unsaturation, each R³ is independently R¹ or —H, m is from 0.001 to 0.3, n is from 0.5 to 0.999, p is from 0 to 0.5, and m+n+p=1, provided the organohydrogenpolysiloxane has an average of at least two silicon-bonded hydrogen atoms per molecule.

3. The silicone composition according to claim 1, wherein x is 0 and z is 0 in the formula (II) of the silicone resin.

4. A silicone adhesive comprising a cured product of the silicone composition according to claim 1.

5. A coated substrate, comprising:
a substrate; and
a silicone adhesive coating on at least a portion of a surface of the substrate, wherein the adhesive coating comprises the silicone adhesive according to claim 4.

6. The coated substrate according to claim 5, wherein the substrate is selected from glass and a reinforced silicone resin film.

7. A laminated substrate, comprising:
a first substrate;
at least one additional substrate overlying the first substrate; and
a silicone adhesive coating on at least a portion of at least one surface of each substrate, provided at least a portion of the adhesive coating is between and in direct contact with opposing surfaces of adjacent substrates, wherein the adhesive coating comprises the silicone adhesive according to claim 4.

8. The laminated substrate according to claim 7, wherein at least one of the substrates is glass.

9. The laminated substrate according to claim 7, wherein at least one of the substrates is a reinforced silicone resin film.

10. The laminated substrate according to claim 8, wherein at least one of the substrates is a reinforced silicone resin film.
